(19) United States
(12) Patent Application Publication
(10) Pub. No.: US 2026/0210238 A1
(43) Pub. Date: Jul. 23, 2026

(54) DATA CAPTURE DEVICE, SYSTEM & METHOD

(71) Applicant: GLOBALTECH CORPORATION PTY LTD, Forrestfield (AU)

(72) Inventor: Khaled Hejleh, Forrestfield (AU)

(21) Appl. No.: 19/140,157

(22) PCT Filed: Dec. 20, 2023
(86) PCT No.: PCT/AU2023/051333

§ 371 Date: Jun. 17, 2025

(30) Foreign Application Priority Data
Dec. 20, 2022 (AU) 2022903923

(51) Int. Cl. E21B 47/12; G06F 1/3206

(52) U.S. Cl. CPC E21B 47/12; G06F 1/3206

(57) ABSTRACT

Running tool/data capture device (20, 220) is deployed downhole (102) with a drill assembly. Core sample is drilled (104) and drilling ceases (106). Core is broken and a physical factor (second factor) associated with core break is measured/sensed/detected/recorded (108)—signature of core break occurring. The signature (second data) is associated to the orientations during ceased drilling before core break (110). Orientation recordings/first data not commenced by sensing or detecting core break. Orientation recordings occur regardless of drilling or not drilling. Relate signature of core break activity to the first data to identify target data orientation recordings having the correct orientation when the core drill and sample were steady. Tool can receive signal downhole initiated at the surface, the signal associated with at least one function of the data capture device and/or with orientation data recorded by the data capture device.

### TECHNICAL FIELD

The present invention relates to a device, a system and/or a method for measuring/capturing data downhole, such as for use in obtaining/identifying core orientation and/or downhole activity.

Embodiments include a device, a system and/or a method for recording orientation of a core sample obtained downhole or capturing downhole geo data, such as magnetic field strength and direction, radiation level and type, video and still images of rock type and rock structure.

Embodiments of the present invention are concerned with the capture of orientation data relating to orientation of a core sample, such as drilled with a coring assembly/core drill.

### BACKGROUND

The taking of core samples from an underground rock body for the purpose of identifying and analysing the orientation and thickness of underground rock and similar strata is well established.

Apparatus used for this purpose usually entails a rotating core drill with a hollow cylindrical cutting bit which cuts a continuous or discontinuous cylindrical core sample. The core sample is fed into an inner tube or core tube attached behind the cutting bit. Once cut, the base of the core sample is broken from the underlying rock and the core tube (containing the core sample) is subsequently withdrawn, either with the coring drill string or at the end of a cable or “wire line”.

At the surface, the orientation of rock strata in the core sample relative to the axis of the borehole is of interest to ensure that the orientation correctly reflects the original orientation of the rock strata from which the core has been cut.

Data capture devices to obtain data about the geometries of the geology, the nature and properties of the rock surrounding the borehole, the condition of the borehole, the operation of the core drilling tool and drilling progress, the orientation and properties of the core sample, core recovery parameters are known. Such devices are known to be used in fixed relationship with an inner tube in core drilling assemblies.

In particular, known core sample orientation devices require the use of time interval recording of orientation measurements while downhole, and a corresponding timer retained at the surface for an operator to subsequently obtain the correct core sample orientation data from the core sample orientation device that was recorded directly before core break was made while drilling had ceased.

However, such arrangements require the operator at the surface to maintain an accurate timer running during the core sampling run so that particular core orientation data can be identified according to a lapsed period of time recorded at the surface. This can lead to inaccuracies, or wasted core sampling runs, due to human error if the operator does not correctly use the surface timer.

Also, if a battery or other power source in the surface timer fails, or if there is a mechanical or electrical failure of the surface timer, the necessary timing at the surface may be lost or at least inaccurate, resulting in incorrect orientation data or no possibility of correct orientation data being accurately identifiable from the recovered core sample orientation device.

Furthermore, avoiding the need for a surface timer reduces operator training complexity and deice/system use knowledge to help with efficiency and reliability of correct results in the field.

Thus, there would be an advantage if it were possible to provide a data capture device for deployment downhole wherein the device records at least one data set relating to one or more downhole variable factors (such as orientation, temperature, sound, acceleration, change or sound/acceleration, pressure, change of pressure or pressure difference, magnetic field direction/strength, gravitational field direction/strength, radiation type/level, images of rock strata and rock structure in a borehole wall downhole) and is able to capture and self-identify and report desired target orientation data.

Embodiments of the present invention are directed to a data capture device which may at least partially overcome or alleviate at least one of the abovementioned disadvantages or provide a useful or commercial alternative choice.

It will be understood that, if a prior art publication is referred to herein, this reference does not constitute an admission that the publication forms part of the common general knowledge in the art in Australia or in any other country.

### SUMMARY

With the aforementioned in mind, an aspect of the present invention provides a data capture device for deployment downhole to obtain data relating to at least one downhole characteristic, wherein the device is arranged and configured to record first data relating to at least a first factor downhole and the device is configured to associate second data relating to at least one variable second factor sensed or measured downhole to the first data to identify target data in the first data.

A further aspect of the present invention provides a method of identifying orientation of a core sample obtained by a core drilling operation, the method including deploying a core drill assembly downhole and a data capture device connected thereto, obtaining a core sample by drilling, receiving a signal downhole wherein the signal is initiated at the surface, the signal being associated with at least one function of the data capture device and/or with orientation data recorded by the data capture device.

Another aspect of the present invention provides a system for identifying orientation of a core sample obtained by a core drilling operation, the system including a core drill assembly for deployment downhole and a data capture device connected thereto, the core drilling assembly configured to obtain a core sample by drilling, the data capture device enabled to receive a signal downhole wherein the signal is initiated at the surface, the signal being associated with at least one function of the data capture device and/or with orientation data recorded by the data capture device.

Another aspect of the present invention includes a method of obtaining or recording orientation relating to a core sample obtained by a core drilling operation, the method including deploying a core drill assembly downhole and a data capture device connected thereto, obtaining a core sample by drilling, receiving a signal downhole wherein the signal is initiated at the surface, the signal being associated with at least one function of the data capture device and/or with orientation data obtained by the data capture device.

Another aspect of the present invention includes a method of obtaining or recording orientation relating to a core sample obtained by a core drilling operation, the method including deploying a core drill assembly downhole and a data capture device connected thereto, obtaining a core sample by drilling, receiving a signal downhole wherein the signal is initiated at the surface, and only upon the data capture device receiving/having received the signal the data capture device measures an orientation of the data capture device.

Another aspect of the present invention provides a system for identifying orientation of a core sample obtained by a core drilling operation, the system including a core drill assembly for deployment downhole and a data capture device connected thereto, the core drilling assembly configured to obtain a core sample by drilling, the data capture device enabled to receive a signal downhole wherein the signal is initiated at the surface, wherein only upon receiving/having received the signal the data capture device is configured to measure an orientation of the data capture device.

Another aspect of the present invention provides a method of obtaining or recording orientation relating to a core sample obtained by a core drilling operation, the method including deploying a core drill assembly downhole and a data capture device connected thereto, obtaining a core sample by drilling, the data capture device receiving a signal downhole wherein the signal is initiated at the surface, wherein the received signal relates to a measure of orientation of the data capture device or causes the data capture device to measure or record the orientation of the data capture device.

Another aspect of the present provides a system for identifying orientation of a core sample obtained by a core drilling operation, the system including a core drill assembly for deployment downhole and a data capture device connected thereto, the core drilling assembly configured to obtain a core sample by drilling, the data capture device enabled to receive a signal downhole wherein the signal is initiated at the surface, wherein the received signal relates to a measure of orientation of the data capture device or causes the data capture device to measure or record the orientation of the data capture device.

The data capture device can be configured to measure and/or record orientation (e.g. of the data capture device itself) only upon receiving the signal.

A return signal from the data capture device (tool) back to the surface can provide confirmation that the data captured device has carried out a predetermined activity following receiving the signal from the surface. Having received the signal, the data capture device can record (such as in an onboard memory) the measured orientation. The recording of the measured orientation may be a roll orientation of the data capture device.

Embodiments need not include timestamping the recorded measure of the orientation or use an internal timer to record the measured orientation. Embodiments of the data capture device need not have a timer for recording orientation measurements.

The data capture device may receive a further signal downhole, wherein the further signal instructs the data capture device to cease recording orientation data, to enter a sleep, to enter a power down/power saving mode or to enter a power off mode, or a combination of ceasing to record orientation data and subsequently to enter the power off, power saving, power down or sleep mode.

The data capture device may autonomously enters a sleep mode, a power down mode, an energy saving mode or an off mode, after recording the measured orientation.

The recorded measure of orientation after receiving the signal may be the only recorded measure of orientation by the data capture device. The data capture device may record orientation only once, preferably roll orientation, more preferably roll and dip orientation (recorded once and associated with each other —e.g. roll and dip at the time of recording or measuring both).

The signal can be initiated aboveground when a core sample has been drilled, drilling has ceased and the core sample is ready to be broken from the parent/mother rock. The signal can be received by the data capture device during a period of no drilling.

Receiving the signal can cause the data capture device to automatically record orientation data/the measure of orientation, preferably at least roll orientation.

The data capture device, on receiving the signal, may take/record the orientation measurement relating to an indication of orientation of an inner tube containing the core sample and/or of the core sample within the inner tube.

Receiving the signal can cause the data capture device to initiate a locking arrangement to lock the data capture device and the inner tube in a fixed relationship. Alternatively, the data capture device and the inner tube can be in fixed relationship when deployed from the surface.

The signal can be initiated by a signalling device aboveground/at the surface mounted to, attached to, operatively connected to or held to a drill string or drill tube of a drilling operation.

The signalling device can create a vibration in the tube/drill string, sends an audio or electrical signal through the tube/drill string, or pulses drilling mud, or a combination of any two or more thereof.

The signalling device may include a handheld device configured to attach to or be used to cause the signal to propagate from the surface to the data capture device.

The signalling device or a communication device may timestamp a time of sending the signal initiated at the surface. The signalling device may timestamp a time of receiving a return signal from the data capture device.

At least one signal relay device may be provided downhole to relay the signal, convert and relay the signal and/or to boost and relay the signal.

The signal may include a signature/sequence of noises within a range of frequencies to travel down the rod/string.

The data capture device may include signal detection means, a receiver or a transceiver.

The data capture device may include signal processing for receiving a vibration, pressure or audio signal, and converting such received signal to an electrical signal.

The signal sent from aboveground may include a coded instruction. The signal may include a Morse code type signal of short, long or combination of short and long, signals, such as pulses, induced into the drill string, drill tube and/or drilling mud.

A signal received confirmation signal may be transmitted back to the surface/aboveground by a return signal transmitter associated with the data capture device to confirm that the sent signal had been received.

The data capture device can record the measured orientation. The orientation is preferably roll orientation about a central longitudinal axis of the data capture device, which can also be a longitudinal axis of the core tube and the core sample. Dip angle and/or azimuth can also be measured by the data capture device.

The data capture device can have an onboard battery for powering a processor, a memory, an analogue to digital converter (A-D) and/or a digital to analogue (D-A) converter, one or more sensors (such as accelerometers), and/or other electronics within the device.

The at least one function of the data capture device may include ceasing the obtaining or recoding of the orientation data, entering or leaving a sleep mode, entering or leaving a power down mode, or entering or leaving an off mode, of the data capture device.

Embodiments include a signal received confirmation signal is transmitted back to the surface/aboveground to confirm that the sent signal had been received. The signal received confirmation signal may confirm that the data captured device has carried out a predetermined activity required by receiving the signal.

The signal received by the data capture device may include an instruction to the data capture device or cause the data capture device to initiate an activity or cease an activity. The instruction may include instructing the data capture device to obtain or record the orientation data. The instruction may include instructing the data capture device to commence recording orientation at time intervals. However, it will be appreciated that embodiments can only require a single orientation recording, which can be a roll orientation (and preferably dip/inclination angle of the data capture device at that roll orientation).

Embodiments may include the data capture device receiving a further signal downhole, wherein the further signal instructs the data capture device to cease recording orientation data, to enter a sleep, to enter a power down/power saving mode or to enter a power off mode, or a combination of ceasing to record orientation data and subsequently to enter the power off, power down or sleep mode.

The data capture device may enter the sleep mode, the power down mode, the energy saving mode or the off mode after receiving the signal or after transmitting the signal received signal.

Embodiments may include the data capture device being deployed downhole, receiving a said signal initiated from the surface and subsequently commencing recording orientation data relatable to orientation of the core sample. The data capture device may be configured to commence orientation recording at time intervals upon or after receiving the signal.

Embodiments may include the data capture device, on receiving the signal, taking/recording a measurement relating to an indication of the orientation of an inner tube containing the core sample and/or of the core sample within the inner tube.

The core sample and the data capture device may be retrieved to the surface, such as by breaking the core sample from the parent/mother rock.

The signal may include or be a unique signature/sequence of noises within a range of frequencies that will efficiently travel down the rod/string e.g. for up to about 3000 m (or further with relaying/boosting).

Embodiments include at least one sensor for sensing or measuring the at least one other/second factor. The at least one sensor may include at least one said sensor for sensing or measuring one or more of the following: orientation, dip or inclination, azimuth, pressure, change of pressure, pressure differential, acceleration, change of acceleration, temperature, change of temperature, vibration, vibration characterisation, change of vibration, audio, sound, strain, radiation, at least one downhole image, or a combination of at least two or more thereof.

The at least one downhole characteristic may include core tube, inner tube and/or core sample orientation.

The target data may include information and/or measurements relating to core tube, inner tube and/or core sample orientation.

Embodiments include the information and/or measurements relating to core tube, inner tube and/or core sample orientation includes inner tube and/or core sample rotational orientation information or measurements, relative to a longitudinal axis of the inner tube, core sample or borehole.

Embodiments of the data capture device may include the respective at least one second factor sensed or measured by a respective onboard sensor of the data capture device or a respective external sensor connected to the data capture device.

The first data associated with the at least a first factor may include orientation data recorded at time intervals.

The first data may relate to rotational orientation of the device about a longitudinal axis of a core drill assembly.

The time intervals for recording data may include regular or irregular time intervals, or a combination thereof.

The first data relating to the at least a first variable factor may include data recorded continuously.

Embodiments of the device are configured to change recording frequency of components of the first data relating to the at least a first variable factor from a first recording frequency and/or pattern to a second recording frequency and/or pattern.

The first data may relate to rotational orientation, the second data relates to sound/audio and/or acceleration measured or sensed downhole, and the device is configured to associate the second data to the first data for use in identifying the target data in the first data.

Embodiments of the device may measure or sense or record, or sense/measure and record, the second factor after recording the first data containing the target data.

The second factor may relate to sensing or measuring breaking of the core.

The sensed or measured or record, or sensed/measure and recorded, second, factor may include at least one of pressure, pressure change, acceleration, change of acceleration, sound, audio or strain, or a combination of any two or more thereof.

A further aspect of the present invention provides a system for obtaining data relating to at least one downhole characteristic, the system including the data capture device of any one of the preceding claims for deployment downhole, and a surface device retained at the surface during downhole deployment of the data capture device, wherein the surface device includes communication means configured to communicate with the data capture device when at the surface.

Preferably, the surface device may include wireless electromagnetic (EM) communication means provided by one or more of Wi-Fi, Bluetooth, infra-red or visible light.

Embodiments of the data capture device may include a processor, data storage and onboard communication means. Embodiments of the device may be arranged and configured to utilise the second data to identify the target data in the first data.

The data capture device may provide a visual indication or audible indication, or both, of rotational orientation, such as one or more lights/LEDs providing a steady or flashing or changing rate of flashing visual indication and/or a steady or intermittent sound or changing rate of intermittent sound indication.

The second data may provide/include an indication of core break and/or an indication of the target data required for core orientation identification recorded prior to core break.

Embodiments include relating the second data to the first data to identify the target data is conducted by the surface device or by a remote device in communication with the surface device or the data capture device, or both.

A further aspect of the present invention includes a method of obtaining data relating to at least one downhole characteristic, the system including a data capture device deployable downhole to obtain data relating to at least one downhole characteristic, wherein the device records first data downhole relating to at least a first factor and the device is configured to associate second data relating to at least one second variable factor sensed or measured downhole to the first data to identify target data in the first data.

The first data may include orientation data. Embodiments include the device recording the first data relating to orientation at regular or irregular time intervals. The time interval recordings can occur continuously during drilling, when drilling has ceased, and after breaking the core sample. For example, the recordings can occur from starting the device running at the surface through to recovery to the surface with the core sample.

The second data may include at least one measurement of the at least one second factor including at least one of orientation, dip or inclination, azimuth, pressure, change of pressure, pressure differential, acceleration, change of acceleration, temperature, change of temperature, vibration, vibration characterisation, change of vibration, audio, sound, strain, radiation, at least one downhole image, or a combination of at least two or more thereof.

The target data may relate to core orientation prior to or at core break and during drilling having ceased.

A visual indication or audible indication, or both, of rotational orientation may be provided, such as by the device providing light and/or sound indications.

Preferably, the device may transmit the first data and the second data, or transmits the target data, or transmits both the first and second data and the target data to a remote device at the surface. Transmission of the respective first, second and/or target data may be by Wi-fi, Bluetooth, infra-red or visible light.

The first data may relate to or be associated with rotational orientation. The second data may relate or be associated with sound/audio and/or acceleration measured or sensed downhole.

The device may be configured to associate the second data to the first data for use in identifying the target data in the first data.

### BRIEF DESCRIPTION OF THE FIGURES

One or more embodiments or examples of the present invention will hereinafter be described with reference to the accompanying Figures, in which:

FIG. 1 shows a general arrangement of a drill assembly for obtaining core sample according to an embodiment of the present invention.

FIG. 2A shows an embodiment of the present invention.

FIG. 2B shows an example of a communication device and signalling device configured for communication, according to an embodiment of the present invention.

FIG. 3 shows a flowchart according to an embodiment of the present invention.

FIG. 4 shows a flowchart according to another embodiment of the present invention.

FIG. 5 shows a flowchart according to a further embodiment of the present invention.

FIG. 6 shows a system according to an embodiment of the present invention.

FIG. 7 shows a system according to a further embodiment of the present invention.

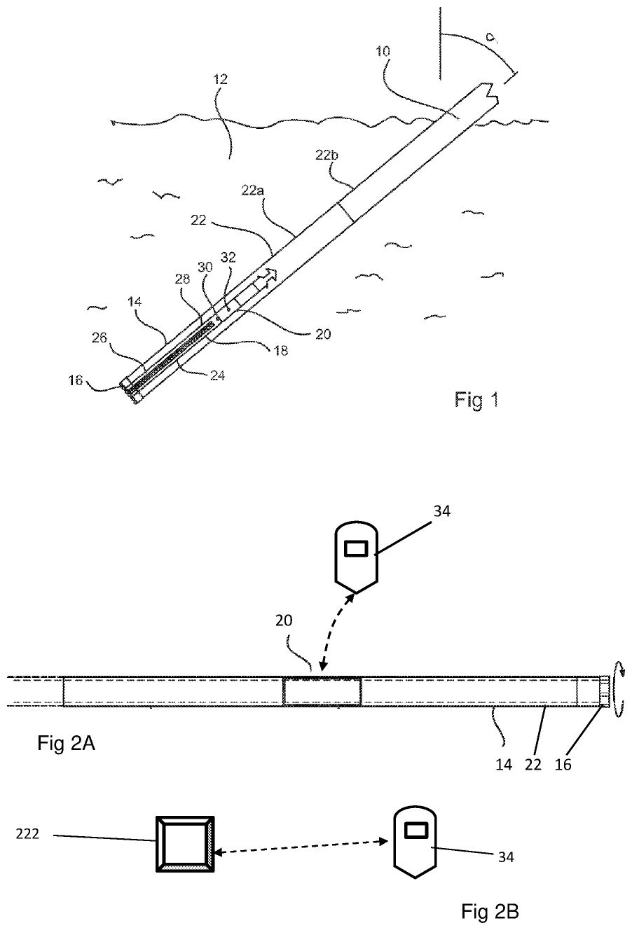

### DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting.

Other embodiments may be utilised and other changes may be made without departing from the spirit or scope of the subject matter presented.

It will be readily understood that the aspects of the present disclosure, as generally described herein and illustrated in the drawings can be arranged, substituted, combined, separated and designed in a wide variety of different configurations, all of which are contemplated in this disclosure.

Embodiments can include a drill assembly 10 for drilling into a subsurface body of material 12 includes a drill string 14 having a drill bit 16, an outer tube 22 formed of linearly connected tube sections 22a,22b . . . , and an inner tube assembly 18 including an inner tube 24 for receiving the core 26 drilled from the subsurface body.

A data capture device 20 (aka ‘tool’) can include a battery to power onboard electronics, such as a processor, memory, one or more sensors (e.g. one or more accelerometers, pressure sensor, vibration sensor, audio sensor).

In use, an operator aboveground/at the surface starts the tool and deploys it downhole with the drilling/coring assembly. Drilling is commenced/recommenced.

Once the drilling is completed and a core sample is obtained, the operator stops the drill from turning. The operator may wait a period of time, such as up to around 10 s. The operator then sends a signal from the surface to the tool downhole.

Upon receiving the signal that was initiated aboveground/at the surface, the tool promptly/immediately takes an orientation measurement and records that measurement.

After a period of at least 10 s after the signal was sent downhole from the surface, the operator breaks the core sample from the main body of rock. The tool, inner tube and the core sample are then retrieved to the surface. At the surface, the operator re-orients the tool and the core sample within the inner tube as per the orientation measurement obtained downhole.

It will be appreciated that time interval orientation recording/measurement from the surface until the core sample is drilled is not required. No orientation recordings during travel of the tool downhole and return uphole are required.

Embodiments provide for the tool (data capture device) to receive the signal from the surface while drilling is ceased, the tool can then record its orientation (and therefore of the fixedly attached inner tube and core sample held within the inner tube. The tool can then return to a sleep/power down mode after recording the orientation.

Furthermore, no timestamping of the single orientation recording is required and no downhole timer is needed (no time interval recording of orientation required).

Preferably, the tool receives the signal which the tool interprets as an instruction to record orientation, the orientation is recorded, and the tool can cease recording/measuring orientation. The tool can optionally power down/enter sleep mode.

The core can then be broken form the parent rock, and the drilling assembly and tool (data capture device) returned to the surface.

At the surface, the tool can be instructed to provide the recorded orientation data. A portable (preferably a hand-held) device or other device at the surface can communicate with the tool to obtain the recorded orientation data.

Although only one orientation recording is required, the tool may record more than one orientation data set while drilling is ceased and the signal has been received.

The tool may transmit a signal received signal back to the surface to confirm receipt of the signal from the surface and/or to confirm orientation data recorded 9which may be just one orientation recording).

Turning the tool on at the surface before deployment downhole can cause one or more embodiments of the tool to turn on a signal listening device (such as an audio signal listening device—e.g. including an audio signal listening circuit and one or more related sensor(s)). The signal listening device activates measurement/recording once the signal is received downhole.

It will be appreciated that the tool not taking orientation measurements before deployment downhole and during descent downhole.

Core drilling commences or recommences if previously started and stopped. The core sample is drilled and received into the inner tube. At any time the operator can stop drilling.

Embodiments include the operator then sending the signal, such as a specific audio signal and/or signal pattern down the hole (e.g. along/through the material of the rod string).

Embodiments include the tool recognising the signal from the surface and one or more embodiments of the tool consequently turns on the onboard accelerometers (such as a tri-axial accelerometer having x, y and z coordinate axes) and preferably takes one orientation measurement and records that measurement in an onboard memory.

One or more embodiments of the tool may also measure/record one or more of dip angle (inclination angle), azimuth, temperature using onboard respective sensor(s).

Once the required orientation is recorded, the tool may then shut down or enter sleep/power saving mode. Preferably, most of the tool's onboard functions can shut down. The operator can break the core at any time after the orientation measurement has been recorded and thereafter retrieve the tool and attached assembly holding the core sample.

Once back at the surface, a communication device can communicate to the tool (data capture device). The tool recognises a communication signal and the tool goes into an orientation mode ready to orient with respect to the recorded orientation.

It will be appreciated that embodiments include no requirement for recording orientation at time intervals. Only the signal from the surface is required while drilling is ceased. No time stamping of the orientation measurement is required and no timer is need for taking the orientation measurement.

Advantageously, avoiding need for recording orientation measurements from tool start up at the surface and during deployment and drilling downhole helps to greatly extended battery life of the tool-which may be more than a year of battery life for a tool only needing to record one orientation measurement per core sample run.

After drilling is ceased, the operator can send the signal down the drill string to the downhole tool to cause the tool to record orientation. The tool may send a return ‘signal received’ signal and/or a return ‘signal acted upon’ (orientation recorded confirmation) signal.

Embodiments include a relatively short wait period (e.g. about 15 s) from sending the signal from the surface to recording orientation in the tool. It will further be appreciated that the drill rig can shut down after drilling the core and recording the orientation for a relatively long period, such a shift changeover, maintenance shutdown, or holiday period, e.g. a month or more, and the captured core orientation data can still be retrieved. Embodiments can include that tool event history can be stored for the life of the tool because of the reduced volume of data-only one measurement per run captured.

Embodiments can include one or more sensors 28,30,32 provided to detect one or more downhole factors (e.g. second downhole factor(s)), such as pressure, change in pressure (Δp) and/or pressure differential (p1−p2), azimuth, dip or inclination (α), temperature (T), change of temperature (ΔT), vibration, vibration characterisation, change of vibration (ΔV), audio/sound, strain, radiation, and/or at least one downhole image, or a combination of at least two or more thereof.

The one or more sensors can be provided as part of an embodiment of the data capture device, or remotely and operatively connected to the data capture device.

Measurement or sensing of one or more such factors can be used in second data to be related to orientation data/first data captured/recorded, such as by an embodiment of the data capture device 20.

Drilling can cease when the desired core sample is obtained, such as in the core tube/inner tube. The core sample can then be broken from the parent rock.

The second factor can relate to the sound associated with breaking the core or the acceleration/change in acceleration by breaking the core sample from the parent rock, or a combination of sound and acceleration/change of acceleration.

It will be appreciated that the sensing/detecting/measuring the second factor does not cause embodiments of the device to record orientation. To the contrary, embodiments of the device can continuously record orientation during drilling, when drilling has ceased (such as immediately prior to breaking the core sample from the parent rock), and after breaking the core sample and returning the device and core drilling assembly with the core sample back to the surface.

Embodiments can include starting the device recording periodically at time intervals at the surface, deploying the core drilling assembly and device downhole, drilling the core sample, breaking the core sample and returning the assembly with core sample and the device back to the surface, and then obtaining an indication of core orientation form the device at the surface orientation recordings can then be stopped at the surface.

It will be appreciated that embodiments detect/sense the second factor, such as a physical characteristic downhole arising from breaking the core sample, and associating that second factor to the first data (the first data preferably containing data relating to core orientation during the period drilling had ceased and before core break).

It will further be appreciated that no timer at the surface is required. Preferably a surface device can be used to start the data capture device running at the surface prior to deployment downhole, and to cause the data capture device to enter orientation mode to give an indication of orientation (such as by the data capture device changing rate of flashing lights or changing pitch or frequency of sound, or both, when recovered to the surface with the core sample in the core/inner tube attached to the data capture device.

Preferably, the data capture device is fixedly attached to the core/inner tube directly or indirectly so that relative rotation is prevented. Alternatively, the data capture device can be attached in rotatable relationship to the core/inner tube and a locking mechanism may deploy to lock the data capture device and the core/inner tube in foxed relationship at or before core break so that orientation data recordings relate to the fixed configuration for accurate orientation data relative to the core sample held in the core/inner tube.

Embodiments of the data capture device (tool) can record data relating to the orientation of the core, such rotational angle about a longitudinal axis and relative to a reference (which may be s selected reference point or an up or downside reference or a gravity max or min value.

Measurement or sensing from the one or more sensors can be used to identify a core break activity, such as sound or movement, or both, of the core tube/inner tube. Such measurement or sensing value(s) can be associated with recorded orientation data (first data) to identify target orientation data within the first data.

For example, when retrieved to the surface, the data capture device can provide target data or the first and second data (first data relating to core orientation recordings and second data relating to the one or more second factor measurements/values).

The second data recorded or used may optionally include ‘dip’ angle, such as to increase reliability of core orientation results.

Dip (also referred to as inclination or declination) is the angle of the inner core tube drill assembly with respect to the horizontal plane and can be the angle above or below the horizontal plane depending on drilling direction from above ground level or from underground drilling in any direction. This provides further confirmation that the progressive drilling of a hole follows a maximum progressive dip angle which may incrementally change as drilling progresses, but not to the extent which exceeds the ‘dogleg severity’. The ‘dogleg severity’ is a normalized estimate (e.g. degrees/30 metre) of the overall curvature of an actual drill-hole path between two consecutive directional survey/orientation stations.

For example, when the data capture device is recovered to the surface, a communication device (remote communicator) 34 can communicate (such as wirelessly) with the data capture device 20 and obtain therefrom the target data relating to core orientation recorded by the data capture device during a period of no drilling and before or at core break (preferably shortly before core break).

Embodiments can include the communication device 34 arranged and configured to communicate with a signalling device 222. The signalling device 222 may be configured to send a signal to the data capture device and/or to receive a signal from the data capture device, when the data capture device is downhole. The communication device 34 may communicate with the signalling device wirelessly or by physical connection.

Prior to breaking the core, the drill operator may wait a period to ensure that the data capture device records a target orientation value for the first data.

Pressure changes or levels may be detected to indicate a pre-break condition or period, such as pressure of mud/water within the inner tube increasing due to the core filling or nearly filling the inner tube holding the core.

If any orientation measurements are taken during descending or ascending, due to sensitivity limitations of the sensors or during erratic silence segments, such measurements can be excluded from the first data as not being target data.

When the drilling ends and the driller is ready to break the core, the driller instructions will be to observe a period of silence (no rotation), (this may typically be greater than 0 s but preferably no longer than 90 seconds).

The data capture device is already running and periodically (regular or irregular intervals) recording orientation.

Dip measurement can be taken during this period of silence. Alternatively, or in addition, sound and/or acceleration or other downhole parameter can be sensed/measured and/or recorded relating to core break. Embodiments include orientation recordings continuing during the silent period and during core break.

The orientation recordings forming at least part of the first data are not caused by the second factor being sensed/detected, rather, the second factor is associated with one or more particular recordings (target data) within the first data. For example, breaking the core is detected (detecting/sensing/measuring the sound of core break and/or sensing/detecting/measuring acceleration or change of acceleration (jerk) during core break, and the orientation recording(s) made immediately before core break being detected are in the target data.

Embodiments create a ‘signature’ of activity including sensed/measured downhole factors such that the signature can be associated with the target data once the data capture device is recovered to the surface. If one of these criteria is not met, then the sample may be discarded.

Alternatively, or in addition, pressure created within the borehole by ‘mud and/or water (which may be pumped down the borehole from the surface) may be detected. Embodiments may include detecting that pressure reaching a certain pressure. One or more pressure sensors may be provided, such in the device or on the drill-string (e.g., on the inner and/or outer drill tube or on the drill bit).

Detected pressure (such as pressure within the inner tube receiving the core) or pressure differential (such as pressure differential between/across the inner and outer tubes, may be indicative of the inner tube being nearly or totally full of core. This occurs before the core is separated from the subsurface body of material (such as by breaking the core from the body by a sharp pull back on the core) and hence provides a ‘signature’ or indicator that the core is about to be broken.

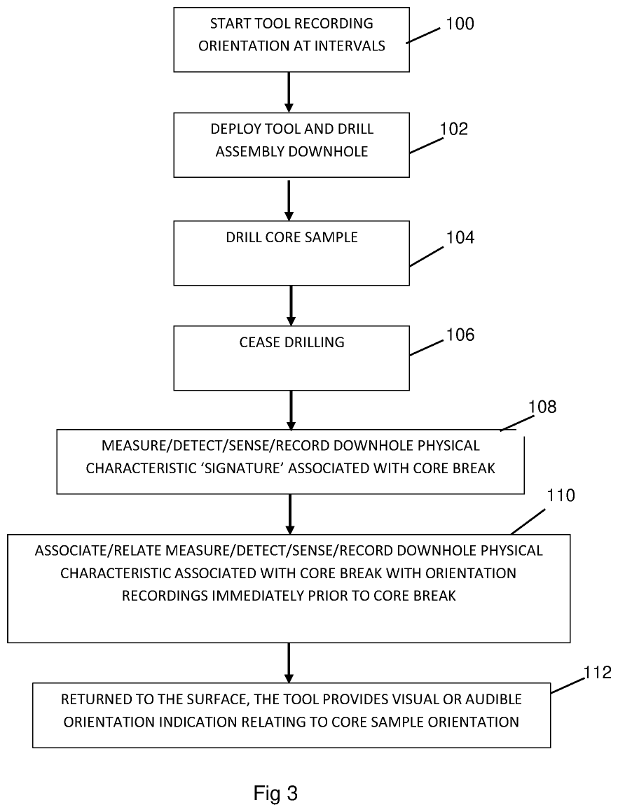

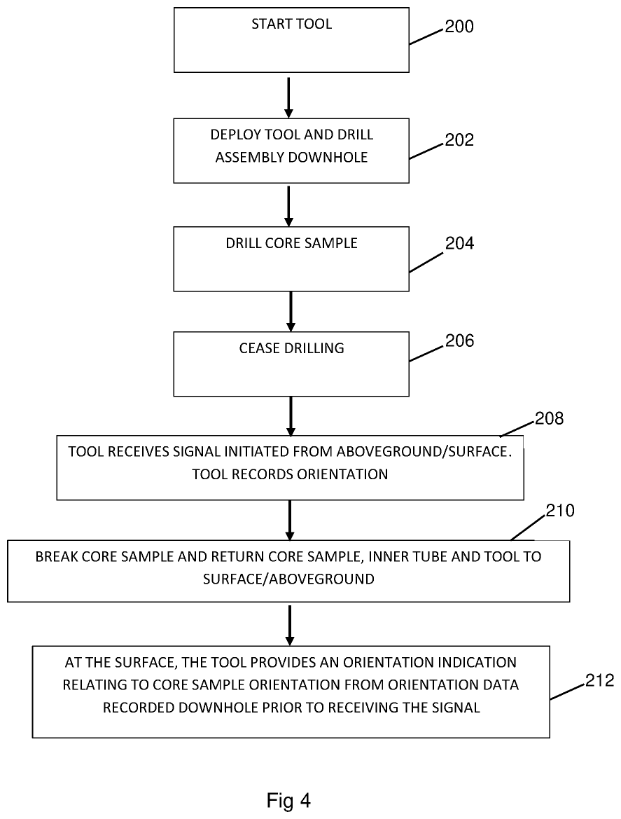

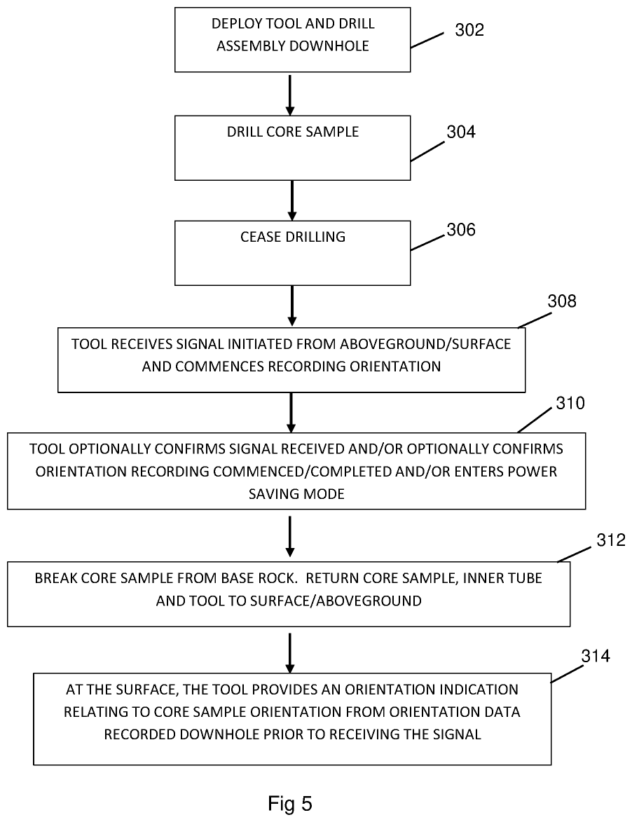

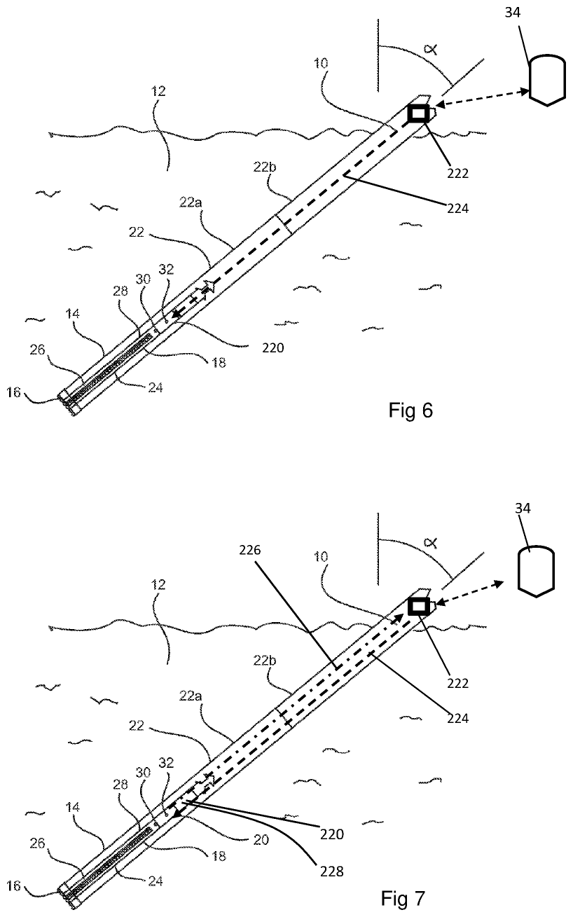

For at least one preferred embodiment as shown in the flowchart by way of example in FIG. 3, core orientation target data to be validated by the correct ‘signature’ being identified.

The tool (data capture device) is started at the surface 100 and deployed downhole 102 attached to a drill assembly. The core sample is drilled 104. Drilling can cease 106. The core is broken and at least one physical factor (second factor) associated with core break is/are measured/sensed/detected/recorded 108—signature of core break occurring. The ‘signature’ (second data) is associated/related to the orientations during ceased drilling (silence) before core break 110. Orientation recordings (first data) are not commenced by sensing or detecting breaking the core, rather, the orientation recordings occur regardless of drilling activity (drilling or not drilling) and the ‘signature’ of core break activity is used to relate to the first data to identify the target data orientation recordings that have the correct orientation when the core drill and sample were steady. At the surface, the tool provides an indication of correct orientation-and can provide an indication of which direction to rotate the tool and/or an indication of approaching the desired rotational orientation, such as by flashing lights faster or slower and/or giving an audible sound/varying an audible sound 112.

Once the required core orientation ‘signature’ target data is obtained, the data capture device may be shutdown or turned to low power standby mode in preparation to be put into running mode again to record fresh first and second data in a further coring run.

Embodiments may include a method of identifying orientation of a core sample obtained by a core drilling operation, the method including deploying 204 a core drill assembly downhole and a data capture device 220 connected thereto (preferably in fixed relationship; however, a fixed relationship between the drill assembly and the data capture device (or ‘tool’) may be established prior to breaking the core e.g. by a locking means initiated prior to core break—such as by the tool receiving the signal initiated at the surface).

The core sample can be drilled 206. Drilling is ceased 208.

The tool (e.g. the data capture device 220) can receive 210 the signal 224 initiated at the surface/aboveground (such as from a signalling device 222 applied to the drill string, drill tube) preferably while drilling is ceased e.g. the drilling is ceased and the signal then sent 208.

Preferably the signal can be associated with at least one function of the data capture device and/or with orientation data recorded by the data capture device.

Once drilling is ceased and the core separated/broken from the parent rock, the inner tube holding the core sample is returned 212 to the surface along with the data capture device 220.

An indication of orientation of the core sample (represented by orientation of the data capture device/tool 220 is obtained—which can be the recorded orientation data immediately prior to receiving the signal or immediately after receiving the signal and before core break.

A device 222 at the surface can be a handheld device (such as for use on recording/displaying drilling related data), which may removably attach to the drill string/drill tube—such as by one or more magnets. The device may include means to initiate a signal into the drill string/drill tube, such as a vibrator, hammer, tapping device—which may be programmable to provide a predetermined code forming all or part of the signal.

Embodiments may include a system for identifying orientation of a core sample obtained by a core drilling operation, the system including a core drill assembly for deployment downhole and a data capture device connected thereto, the core drilling assembly configured to obtain a core sample by drilling, the data capture device enabled to receive a signal downhole wherein the signal is initiated at the surface, the signal being associated with at least one function of the data capture device and/or with orientation data recorded by the data capture device.

Embodiments may include the at least one function of the data capture device including ceasing recoding of orientation data, a sleep mode or power down mode or off mode of the data capture device.

The core sample and the data capture device may be retrieved to the surface, such as by breaking the core sample from the parent/mother rock.

The data capture device may transmit a signal received confirmation signal back to the surface/aboveground to confirm that the sent signal had been received. The data capture device may go into a sleep mode, power down mode or off mode after transmitting the signal received signal.

Embodiments include initiating the signal aboveground (e.g. at the surface) when a core sample has been drilled, drilling has ceased and the core sample is ready to be broken from the parent/mother rock. Preferably the signal is received during a quiet period of no drilling.

Embodiments include reception of the signal by the data capture device causing the data capture device to record orientation data or to note already recorded orientation data.

Embodiments include associating the signal with data relating to core orientation recorded by the data capture device.

Embodiments include the data capture device, on receiving the signal, taking a measurement that is an indication of the orientation of an inner tube containing the core sample and/or of the core sample within the innertube.

Embodiments include initiating the signal at the surface, sending the signal from the surface to the data capture device, where the device upon receiving the signal records data relating to orientation of the inner tube and/or of the core sample.

Embodiments of the present invention include the data capture device and the inner tube being in a fixed relationship. Preferably, receiving the signal initiates a locking arrangement to lock the data capture device and the inner tube in a fixed relationship, preferably a fixed relationship preventing relative rotation about a longitudinal axis of the inner tube and/or the core sample.

Embodiments include the data capture device going into a sleep mode, power down mode or turning off once the signal has been received and the orientation data of interest noted, recorded or identified. The orientation data of interest can be data relating to orientation of the data capture device, and therefore of the inner tube and core sample in fixed relationship, preferably immediately prior to breaking of the core sample from parent/mother rock.

The signal may be initiated by a device aboveground/at the surface. For example, a signalling device may be mounted/attached (such as by one or more magnets) to a drill string or drill tube of a drilling operation wherein the data capture device, inner tube and core sample are downhole.

The signalling device may create a vibration in the tube/drill string, may send an audio or electrical signal through the tube/drill string, may pulse drilling mud, or a combination of any two or more thereof.

The signalling device may include a handheld device configured to attach to or be used, such as by a drilling operator or by another personnel, to cause the signal to propagate from the surface to the data capture device.

One or more signal relay devices may be provided downhole, such as to relay the signal, convert and relay the signal, o and/or to boost the signal.

The signal may include or be a unique signature/sequence of noises within a range of frequencies that will efficiently travel down the rod/string e.g. for up to about 3000 m (or further with relaying/boosting).

The data capture device may include signal detection means, such as a receiver or transceiver. Preferably, the data capture device includes signal processing—such as receiving a vibration or audio signal, and converting such received signal to an electrical signal (processing may include analogue to digital conversion).

The signal sent from aboveground may include or be a Morse Code type signal of short, long or combination of short and long, signals, such as pulses, induced into the drill string, drill tube and/or drilling mud.

Embodiments include at least one sensor for sensing or measuring the at least one second factor. The at least one sensor may include at least one said sensor for sensing or measuring one or more of the following: orientation, dip or inclination, azimuth, pressure, change of pressure, pressure differential, acceleration, change of acceleration, temperature, change of temperature, vibration, vibration characterisation, change of vibration, audio, sound, strain, radiation, at least one downhole image, or a combination of at least two or more thereof.

Starting and shutting down of the data capture device can be done at the surface, such as by operating a reed switch within the device—such as by an external magnet or other control device. It will be appreciated that the data capture device only needs to be switched on and will then continue to make orientation recordings until shutdown on return to the surface and after the device is orientated and the core sample can be subsequently marked.

Having receive the signal initiated from the surface, the data capture device may power up (such as from a sleep/energy saving mode) to commence recording orientation related data (such as by one or more accelerometers to record orientation of the data capture device). Such orientation recording may be at time intervals.

The data capture device may have a timer 228 and may cease recording orientation after an elapsed time, preferably a predetermined elapsed time. However, a further signal may be initiated at the surface, which further signal may instruct the data capture device to cease recording orientation and preferably enter a sleep/low power mode or off mode for return to the surface.

The data capture device may send a confirmation signal 226 to the surface to confirm receipt of the received signal and/or to confirm an activity has occurred or instruction carried out, such as recording orientation, starting of the timer 228, ending of the timer, going into low power/energy saving/sleep mode, or a combination of two or more thereof.

Embodiments require no surface timer or ‘Mark’ needed at the surface. The operator can stop/cease drilling when sufficient core sample is in the core tube, wait while the data capture device records one or more orientation recordings while drilling is ceased, and then breaks the core sample from the parent rock.

It will be appreciated that the signal initiated at the surface can cause the data capture device to commence recording orientation. The data capture device can record orientation for a present time, such as determined by a timer of the device, or a further signal from the surface (such as prior to core break) can be sent to cause the data capture device to cease recording orientation.

Avoiding the need for time interval recording during transit downhole (down and up) saves battery power and avoids the need for many data recording that are of no use because they are taken during movement or during transit and are insufficiently accurate or not valid for core sample orientation.

Embodiments include a physical factor (second factor) being detected associated with the core break activity (sound and/or acceleration factors are preferred) and used to associate to the orientation recordings to identify desired target orientation recordings. The target orientation recording(s) (target data) is/are used to provide the visual/sound indication of the desired orientation and/or direction to rotate the data capture device when at the surface to give an indication of the desired orientation matching the core sample orientation when downhole (up or down mark).

Embodiments can include deploying the tool (e.g. data capture device) and drilling assembly 302. Drilling a core sample 304. Ceasing drilling 306. The tool receives a signal initiated from the surface 308. The tool can commence or continue recording orientation (such as by commencing recording at time intervals or commencing a set number of orientation data recordings). The tool may send a signal received signal as confirmation back to the surface 310. The core sample is broken from the base rock and is returned 312 to the surface with the tool. Orientation data is obtained 314 from the tool.

Receiving the signal may be during a period when drilling has ceased. A locking mechanism may be actuated upon or after receiving the signal to lock the data capture device to the core tube in fixed relationship. However, such fixed relationship may be established t the surface before deployment.

One or more embodiments can provide a data capture device for deployment downhole to obtain data relating to at least one downhole characteristic, wherein the device is arranged and configured to record first data relating to at least a first factor downhole and the device is configured to associate second data relating to at least one variable second factor sensed or measured downhole to the first data to identify target data in the first data.

The data capture device can include at least one sensor for sensing or measuring the at least one second factor. The at least one sensor can include at least one said sensor for sensing or measuring one or more of the following: orientation, dip or inclination, azimuth, pressure, change of pressure, pressure differential, acceleration, change of acceleration, temperature, change of temperature, vibration, vibration characterisation, change of vibration, audio, sound, strain, radiation, at least one downhole image, or a combination of at least two or more thereof.

The at least one downhole characteristic can include core tube, inner tube and/or core sample orientation.

The target data can include information and/or measurements relating to core tube, inner tube and/or core sample orientation.

The information and/or measurements relating to core tube, inner tube and/or core sample orientation can include inner tube and/or core sample rotational orientation information or measurements, relative to a longitudinal axis of the inner tube, core sample or borehole.

The respective at least one second factor can be sensed or measured by a respective onboard sensor of the data capture device or a respective external sensor connected to the data capture device.

The first data can relate to the at least a first factor includes orientation data recorded at time intervals.

The first data can relate to rotational orientation of the device about a longitudinal axis of a core drill assembly.

The time intervals for recording data can include regular or irregular time intervals, or a combination thereof.

The first data relating to the at least a first variable factor can include data recorded continuously.

The data capture device can be arranged and configured to change recording frequency of components of the first data relating to the at least a first variable factor from a first recording frequency and/or pattern to a second recording frequency and/or pattern.

The first data can relate to rotational orientation, the second data relates to sound/audio and/or acceleration measured or sensed downhole, and the device is configured to associate the second data to the first data for use in identifying the target data in the first data.

The data capture device can measure or sense the second factor after recording the first data containing the target data. The second factor can relate to sensing or measuring breaking of the core. The sensed or measured second factor can include at least one of pressure, pressure change, acceleration, change of acceleration, sound, audio or strain, or a combination of any two or more thereof.

One or more embodiments can provide a system for obtaining data relating to at least one downhole characteristic, the system including the data capture device of any one of the preceding claims for deployment downhole, and a surface device retained at the surface during downhole deployment of the data capture device, wherein the surface device includes communication means configured to communicate with the data capture device when at the surface.

The surface device can include wireless electromagnetic (EM) communication means provided by one or more of Wi-Fi, Bluetooth, infra-red or visible light.

The data capture device can include a processor, data storage and onboard communication means, and is arranged and configured to utilise the second data to identify the target data in the first data.

The device can provide a visual indication or audible indication, or both, of rotational orientation.

The second data can provide an indication of core break and/or an indication of the target data required for core orientation identification recorded prior to core break.

Relating the second data to the first data to identify the target data can be conducted by the surface device or by a remote device in communication with the surface device or the data capture device, or both.

One or more embodiments can provide a method of obtaining data relating to at least one downhole characteristic, the system including a data capture device deployable downhole to obtain data relating to at least one downhole characteristic, wherein the device records first data downhole relating to at least a first factor and the device is configured to associate second data relating to at least one second variable factor sensed or measured downhole to the first data to identify target data in the first data.

The first data can include orientation data. The device may record the first data relating to orientation at regular or irregular time intervals. The time interval recording can occur continuously during drilling and when drilling has ceased.

The second data can include at least one measurement of the at least one second factor including at least one of orientation, dip or inclination, azimuth, pressure, change of pressure, pressure differential, acceleration, change of acceleration, temperature, change of temperature, vibration, vibration characterisation, change of vibration, audio, sound, strain, radiation, at least one downhole image, or a combination of at least two or more thereof.

The target data can relate to core orientation prior to or at core break and during drilling having ceased.

The data capture device may provide a visual indication or audible indication, or both, of rotational orientation.

The data capture device may transmit the first data and the second data, or transmits the target data, or transmits both the first and second data and the target data to a remote device at the surface.

The transmission of the respective first, second and/or target data may be by Wi-fi, Bluetooth, infra-red or visible light.

The first data may relate to rotational orientation, the second data may relate to sound/audio and/or acceleration measured or sensed downhole, and the device may be configured to associate the second data to the first data for use in identifying the target data in the first data.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of obtaining or recording orientation relating to a core sample obtained by a core drilling operation, the method including deploying a core drill assembly downhole and a data capture device connected thereto, obtaining a core sample by drilling, the data capture device receiving a signal downhole wherein the signal is initiated at the surface, wherein the received signal relates to a measure of orientation of the data capture device or causes the data capture device to measure or record the orientation of the data capture device.

2. The method of claim 1, wherein, only upon receiving the signal the data capture device measures and/or records the orientation.

3. The method of claim 1, wherein the data capture device sends a return signal back to the surface/aboveground confirming that the data capture device received the signal from the surface.

4. The method of claim 3, wherein the return signal confirms that the data captured device has carried out a predetermined activity following receiving the signal from the surface.

5. The method of claim 1, wherein, having received the signal, the data capture device records the measured orientation.

6. The method of claim 5, wherein the recording of the measured orientation includes roll orientation.

7. (canceled)

8. The method of claim 1, including the data capture device receiving a further signal downhole, wherein the further signal instructs the data capture device to cease recording orientation data, to enter a sleep, to enter a power down/power saving mode or to enter a power off mode, or a combination of ceasing to record orientation data and subsequently to enter the power off, power down or sleep mode.

9. The method of claim 1, wherein the data capture device autonomously enters a sleep mode, a power down mode, an energy saving mode or an off mode, after recording the measured orientation.

10. (canceled)

11. The method of claim 1, including initiating the signal aboveground when a core sample has been drilled, drilling has ceased and the core sample is ready to be broken from the parent/mother rock, and wherein the signal is received by the data capture device during a period of no drilling.

12. (canceled)

13. The method of claim 1, including receiving the signal causes the data capture device to automatically record orientation data.

14. The method of claim 1, including, the data capture device, on receiving the signal, taking/recording the orientation measurement relating to an indication of orientation of an inner tube containing the core sample and/or of the core sample within the inner tube.

15. The method of claim 1, wherein receiving the signal initiates a locking arrangement to lock the data capture device and the inner tube in a fixed relationship.

16. The method of any claim 1, wherein the signal is initiated by a signalling device aboveground/at the surface mounted to, attached to, operatively connected to or held to a drill string or drill tube of a drilling operation.

17. The method of claim 16, wherein the signalling device creates a vibration in the tube/drill string, sends an audio or electrical signal through the tube/drill string, or pulses drilling mud, or a combination of any two or more thereof.

18. (canceled)

19. The method of claim 16, wherein the signalling device timestamps a time of sending the signal initiated at the surface, and wherein the signalling device timestamps a time of receiving a return signal from the data capture device.

20. (canceled)

21. The method of claim 1, wherein at least one signal relay device is provided downhole to relay the signal, convert and relay the signal and/or to boost and relay the signal.

22. The method of claim 1, wherein the signal includes a signature/sequence of noises within a range of frequencies to travel down the rod/string.

23. The method of claim 1, wherein the data capture device includes signal detection means, a receiver or a transceiver, and a signal processing means for receiving a vibration, pressure or audio signal, and converting such received signal to an electrical signal.

24. (canceled)

25. The method of claim 1, wherein the signal sent from aboveground includes a Morse code type signal of short, long or combination of short and long, signals, such as pulses, induced into the drill string, drill tube and/or drilling mud.

26. A system for identifying orientation of a core sample obtained by a core drilling operation, the system including a core drill assembly for deployment downhole and a data capture device connected thereto, the core drilling assembly configured to obtain a core sample by drilling, the data capture device enabled to receive a signal downhole wherein the signal is initiated at the surface, wherein the received signal relates to a measure of orientation of the data capture device or causes the data capture device to measure or record the orientation of the data capture device.

27.-39. (canceled)
